(19) United States
(12) Patent Application Publication
(10) Pub. No.: US 2025/0255701 A1
(43) Pub. Date: Aug. 14, 2025

(54) COMPACT LIQUID-OUTLET SYSTEM AND ORAL CLEANING METHOD

(71) Applicants: Bixdo (SH) Healthcare Technology Co.,Ltd., Shanghai (CN); GuangDong Bixdo Health Technology Co.,Ltd., Foshan (CN)

(72) Inventor: Jiaquan FU, Shanghai (CN)

(73) Assignees: Bixdo (SH) Healthcare Technology Co.,Ltd., Shanghai (CN); GuangDong Bixdo Health Technology Co.,Ltd., Foshan (CN)

(21) Appl. No.: 18/851,676

(22) PCT Filed: Aug. 24, 2023
(86) PCT No.: PCT/CN2023/114728

§ 371 Date: Sep. 26, 2024

(30) Foreign Application Priority Data
Nov. 4, 2022 (CN) 2022113794009

(51) Int. Cl. A61C 17/02; A61H 13/00

(52) U.S. Cl. CPC A61C 17/02; A61H 13/005; A61H 2201/5051

(57) ABSTRACT

A compact liquid-outlet system comprising a liquid pump device, a liquid-inlet flow channel, and a liquid-outlet flow channel and an oral cleaning method. The liquid pump device comprises a liquid pump cavity, a piston slidably disposed in the liquid pump cavity, and a piston rod. The piston rod extends through the liquid pump cavity in a liquid-tight manner and is connected to the piston. The piston divides a pump chamber of the liquid pump cavity into a rod chamber and a rodless chamber. The piston comprises a liquid-outlet one-way valve allowing only liquid to flow from the rod chamber to the rodless chamber. The liquid-inlet flow channel communicates with the rod chamber through a liquid-inlet one-way valve. The liquid-outlet flow channel communicates with the rodless chamber. This system eliminates the need of extra space for installing the liquid-outlet one-way valve, resulting in a more compact structure.

### FIELD OF THE INVENTION

The present disclosure relates to the technical field of oral cleaning, and in particular, to a compact liquid-outlet system and an oral cleaning method.

### BACKGROUND OF THE INVENTION

As living standards improve, people are becoming increasingly conscious of oral hygiene. Among various oral cleaning tools available on the market, dental irrigators have emerged as essential household appliances, serving as substitutes for traditional dental floss. Their basic working principle involves using a pump to draw water from a water tank, and the extracted water is then sprayed through a nozzle at high pressure several hundred to over a thousand times per minute. This powerful pulsating water stream effectively cleans food debris and dental plaque, and massages the gums, thereby enhancing oral health.

Traditional pulse-type dental irrigators rely on both pulse and water pressure as key mechanisms for effective cleaning. To achieve optimal cleaning results, it is crucial to maintain a longer duration of pulsating water flow in the dental irrigator.

The water flow of the traditional dental irrigator is low both before and after the flow peak, resulting in weak water pressure and inefficient water usage. Additionally, due to the bulky design of the pump structure, the traditional dental irrigator is not convenient for carrying or gripping.

### SUMMARY OF THE INVENTION

In view of the above-mentioned shortcomings, the present disclosure provides a compact liquid-outlet system and an oral cleaning method, which eliminates the need of extra space for installing the liquid-outlet one-way valve, resulting in a more compact structure, especially beneficial for small products like portable dental irrigators.

The compact liquid-outlet system comprises a liquid pump device, a liquid-inlet flow channel, and a liquid-outlet flow channel.

The liquid pump device comprises a liquid pump cavity, a piston, and a piston rod. The piston is slidably disposed in the liquid pump cavity, and the piston rod extends through the liquid pump cavity in a liquid-tight manner and is connected to the piston. The piston divides a pump chamber of the liquid pump cavity into a rod chamber and a rodless chamber. The piston comprises a liquid-outlet one-way valve allowing only liquid to flow from the rod chamber to the rodless chamber.

The liquid-inlet flow channel is communicated with the rod chamber through a liquid-inlet one-way valve.

The liquid-outlet flow channel is communicated with the rodless chamber.

Preferably, the liquid-outlet one-way valve comprises a liquid-outlet valve chamber, a liquid-outlet valve core, and a liquid-outlet valve seat. The liquid-outlet valve chamber is formed in the piston and has an opening facing the rodless chamber, the liquid-outlet valve core is floatingly disposed in the liquid-outlet valve chamber, and the liquid-outlet valve seat is formed in the piston and is disposed at a side of the liquid-outlet valve chamber away from the rodless chamber. The liquid-outlet valve seat is provided with an overflow hole for communicating the liquid-outlet valve chamber and the rod chamber. The liquid-outlet valve core abuts the liquid-outlet valve seat when the piston performs an exhaust stroke, and the liquid-outlet valve core is spaced apart from the liquid-outlet valve seat when the piston performs a suction stroke.

Preferably, the compact liquid-outlet system further comprises a nozzle communicated with the liquid-outlet flow channel. The rodless chamber is in a negative pressure state when the piston performs a suction stroke, during which time a volume increase of the rodless chamber is greater than a volume decrease of the rod chamber.

Preferably, the compact liquid-outlet system further comprising a release system. The release system comprises a release flow channel and a post-peak release mechanism. The release flow channel is communicated with the rodless chamber, and the post-peak release mechanism is configured to block the release flow channel. The post-peak release mechanism is configured to open the release flow channel only when the piston performs the exhaust stroke and after a flow peak occurs in the liquid pump device.

Preferably, the post-peak release mechanism comprises a moving rod and an elastic reset member. The moving rod extends through the liquid pump cavity, and the elastic reset member is configured for driving the moving rod to reset. A first end of the moving rod is provided with a release valve core for blocking the release flow channel, and a second end of the moving rod is provided with a top-abutting member. The top-abutting member abuts the liquid-outlet one-way valve or the piston after the flow peak occurs in the liquid pump device.

Preferably, the release flow channel comprises a vertical flow channel segment and a transverse flow channel segment. The vertical flow channel segment extends along an axial direction of the liquid pump cavity to communicate with the rodless chamber, and the transverse flow channel segment extends along a radial direction of the liquid pump cavity to communicate with the vertical flow channel segment. The moving rod extends through the vertical flow channel segment in a clearance manner, and the top-abutting member extends into the rodless chamber or the liquid-outlet valve chamber to limit the liquid-outlet valve core in the liquid-outlet valve chamber.

Preferably, the liquid pump cavity comprises a liquid-inlet adapter and a liquid-outlet adapter socketed to each other, and a first groove structure of the liquid-inlet adapter and a second groove structure of the liquid-outlet adapter jointly define the pump chamber of the liquid pump cavity.

Preferably, the liquid-outlet flow channel comprises a nozzle jack and a guiding channel both formed in the liquid pump cavity, and the guiding channel is communicated with the nozzle jack and the rodless chamber, respectively.

Preferably, the liquid pump cavity is provided with a first sealing ring and a second sealing ring. The first sealing ring is slidably arranged around the piston in a liquid-tight manner, the second sealing ring is slidably arranged around the piston rod in a liquid-tight manner, and a maximum sealing pressure of the first sealing ring is greater than a maximum sealing pressure of the second sealing ring.

The oral cleaning method applies the above compact liquid-outlet system, and is performed by: pulling back the piston through the piston rod to perform the suction stroke, closing the liquid-inlet one-way valve, and opening the liquid-outlet one-way valve, such that liquid in the rod chamber flows to the rodless chamber through the liquid-outlet one-way valve, and liquid in the nozzle flows back to the rodless chamber; pushing out the piston through the piston rod to perform the exhaust stroke, opening the liquid-inlet one-way valve, and closing the liquid-outlet one-way valve, such that liquid in the liquid-inlet flow channel flows to the rod chamber through the liquid-inlet one-way valve, and liquid in the rodless chamber flows to the nozzle through the liquid-outlet flow channel; part of the liquid in the rodless chamber flows back to a liquid storage tank through the release flow channel after the flow peak occurs in the liquid pump device.

As decreased above, the compact liquid-outlet system and the oral cleaning method of the present disclosure have the following beneficial effects. When the piston is pulled back through the piston rod to perform the suction stroke, an internal pressure of the rod chamber increases and an internal pressure of the rodless chamber decreases, during which time the liquid-inlet one-way valve switches to a closed state and the liquid-outlet one-way valve switches to an open state, such that liquid in the rod chamber can overcome a closing pre-tightening force of the liquid-outlet one-way valve and flow into the rodless chamber. When the piston is pushed out through the piston rod to perform the exhaust stroke, the internal pressure of the rod chamber decreases and the internal pressure of the rodless chamber increases, the liquid-inlet one-way valve switches to an open state, and liquid in the liquid-inlet flow channel can overcome a closing pre-tightening force of the liquid-inlet one-way valve and flow into the rod chamber, during which time the liquid-outlet one-way valve switches to a closed state, and liquid in the rodless chamber is squeezed into the liquid-outlet flow channel through the piston. One major innovation of the compact liquid-outlet system lies in the setting of the liquid-outlet one-way valve. The liquid-outlet one-way valve is integrated in the internal structure of the piston within the liquid pump device, resulting in a more compact design, which is particularly beneficial for small products like portable dental irrigators. Therefore, the compact liquid-outlet system of the present disclosure eliminates the need of extra space for installing the liquid-outlet one-way valve, resulting in a more compact structure, especially beneficial for small products like portable dental irrigators. Additionally, the oral cleaning method of the present disclosure conserves liquid before and/or after flow peaks, enhancing convenience during oral hygiene procedures.

### BRIEF DESCRIPTION OF DRAWINGS

FIG. 1 shows a front view of a compact liquid-outlet system of the present disclosure.

FIG. 2 shows a cross-sectional view of the compact liquid-outlet system along A-A in FIG. 1 during a suction stroke.

FIG. 3 shows a cross-sectional view of the compact liquid-outlet system along B-B in FIG. 2 during the suction stroke.

FIG. 4 shows a cross-sectional view of the compact liquid-outlet system along A-A in FIG. 1 during an exhaust stroke.

FIG. 5 shows an enlarged view of portion C in FIG. 4.

FIG. 6 shows a cross-sectional view of the compact liquid-outlet system along B-B in FIG. 2 during the exhaust stroke.

FIG. 7 shows an enlarged view of portion D in FIG. 6.

FIG. 8 shows an assembly diagram of a liquid-outlet adapter and a nozzle.

FIG. 9 shows a first perspective view of the liquid-outlet adapter.

FIG. 10 shows a second perspective view of the liquid-outlet adapter.

FIG. 11 shows an exploded view of a post-peak release mechanism, a liquid-outlet one-way valve, a piston, and a piston rod.

### REFERENCE NUMERALS

1 Liquid pump device
11 Liquid pump cavity
111 Liquid-inlet adapter
112 Liquid-outlet adapter
12 Piston
13 Piston rod
14 Rod chamber
15 Rodless chamber
16 First sealing ring
17 Second sealing ring
18 Transmission mechanism
19 Driving mechanism
2 Liquid-outlet one-way valve
21 Liquid-outlet valve chamber
22 Liquid-outlet valve core
23 Liquid-outlet valve seat
231 Overflow hole
3 Liquid-inlet flow channel
4 Liquid-inlet one-way valve
5 Liquid-outlet flow channel
51 Nozzle jack
52 Guiding channel
6 Nozzle
7 Release system
71 Release flow channel
711 Vertical flow channel segment
712 Transverse flow channel segment
72 Post-peak release mechanism
721 Moving rod
722 Elastic reset member
723 Release valve core
724 Top-abutting member

### DETAILED DESCRIPTION OF THE INVENTION

The embodiments of the present disclosure will be described below. Those skilled can easily understand disclosure advantages and effects of the present disclosure according to contents disclosed by the specification.

It should be noted that the structure, ratio, size, etc. shown in the accompanying drawings in this specification are only used to illustrate the content disclosed in the specification for the understanding and reading of those familiar with this technology, and are not intended to restrict the implementation of the present invention. Any structural modification, proportional relationship change or size adjustment should still fall within the scope of the present disclosure, given that no effect and objective achievable by the present disclosure are hindered. In the meantime, the terms “upper”, “lower”, “left”, “right”, “intermediate” and “one” as used in this specification are also for convenience of description, and are not intended to restrict the scope of the present disclosure, and the change or adjustment of the relative relationship is considered to be within the scope of the present disclosure without substantial changes in technology.

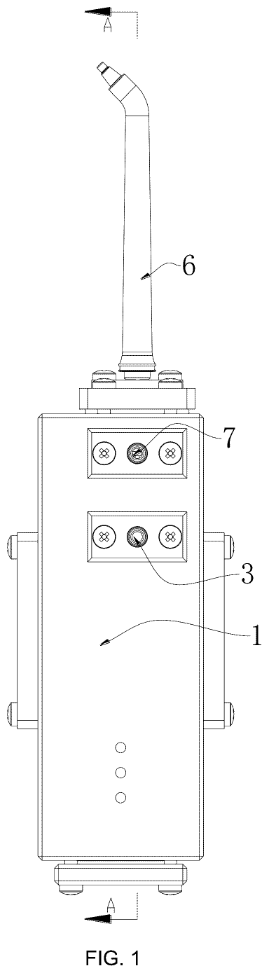

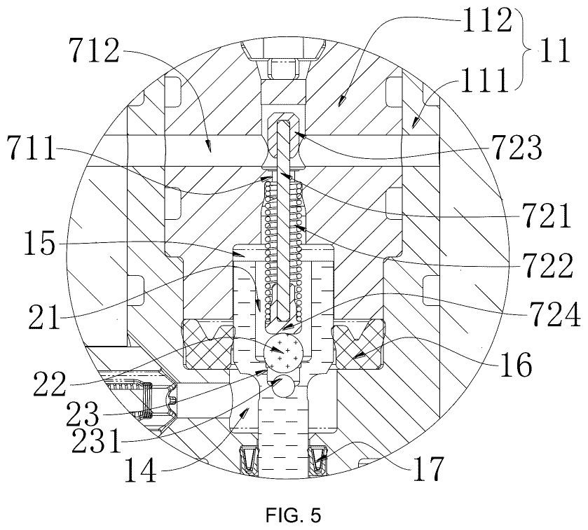

As shown in FIGS. 1-7, the present disclosure provides a compact liquid-outlet system. The compact liquid-outlet system comprises a liquid pump device 1, a liquid-inlet flow channel 3, and a liquid-outlet flow channel 5.

The liquid pump device 1 comprises a liquid pump cavity 11, a piston 12, and a piston rod 13. The piston 12 is slidably disposed in the liquid pump cavity 11, and the piston rod 13 extends through the liquid pump cavity 11 in a liquid-tight manner and is connected to the piston 12. The piston 12 divides a pump chamber of the liquid pump cavity 11 into a rod chamber 14 and a rodless chamber 15. The piston 12 comprises a liquid-outlet one-way valve 2 allowing only liquid to flow from the rod chamber 14 to the rodless chamber 15.

The liquid-inlet flow channel 3 is communicated with the rod chamber 14 through a liquid-inlet one-way valve 4.

The liquid-outlet flow channel 5 is communicated with the rodless chamber 15.

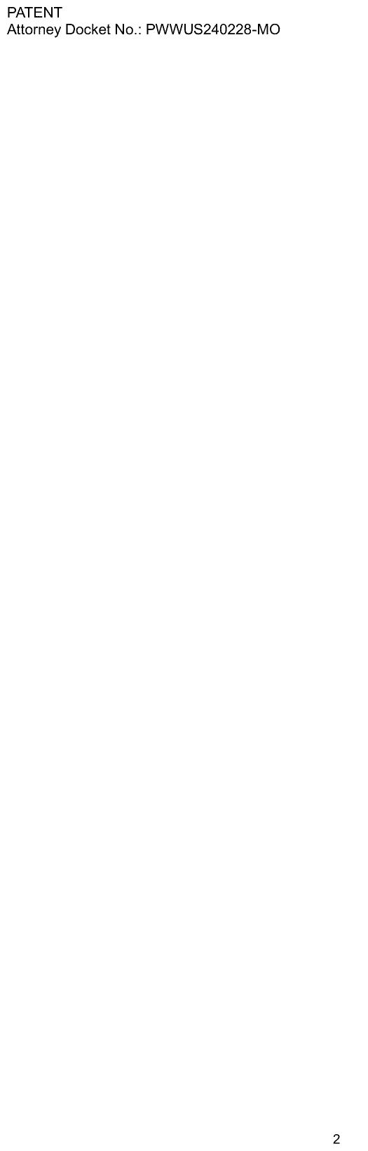

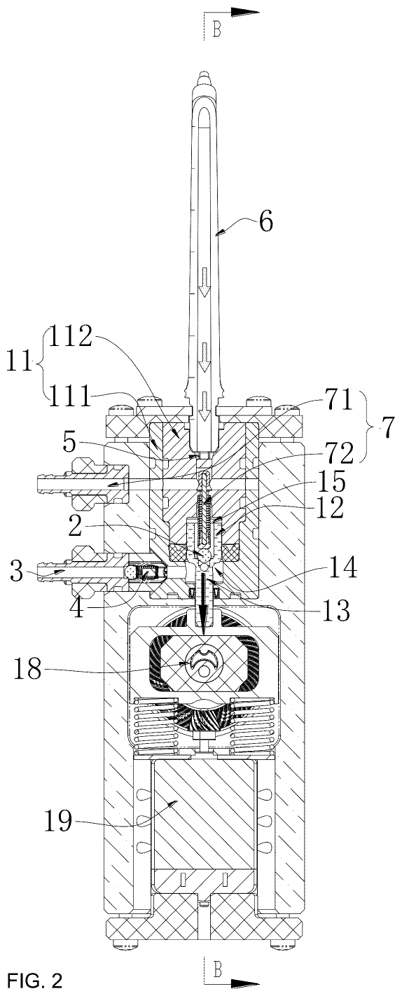

Referring to FIGS. 2 and 3, when the piston 12 is pulled back through the piston rod 13 to perform a suction stroke, an internal pressure of the rod chamber 14 increases and an internal pressure of the rodless chamber 15 decreases, during which time the liquid-inlet one-way valve 4 switches to a closed state and the liquid-outlet one-way valve 2 switches to an open state, such that liquid in rod chamber 14 can overcome a closing pre-tightening force of the liquid-outlet one-way valve 2 and flow into the rodless chamber 15.

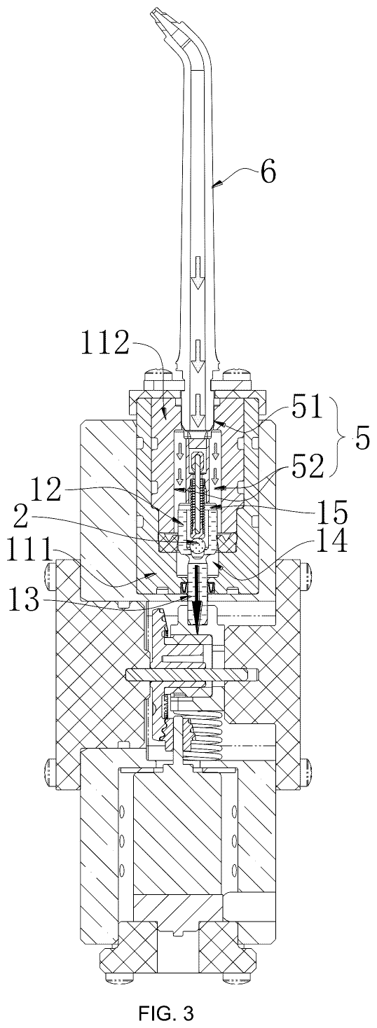

Referring to FIGS. 4, 5, 6 and 7, when the piston 12 is pushed out through the piston rod 13 to perform the exhaust stroke, the internal pressure of the rod chamber 14 decreases and the internal pressure of the rodless chamber 15 increases, the liquid-inlet one-way valve 4 switches to an open state, and liquid in liquid-inlet flow channel 3 can overcome a closing pre-tightening force of the liquid-inlet one-way valve 4 and flow into the rod chamber 14, during which time the liquid-outlet one-way valve 2 switches to a closed state, and liquid in rodless chamber 15 is squeezed into the liquid-outlet flow channel 5 by the piston 12.

The major innovation of the compact liquid-outlet system lies in the setting of the liquid-outlet one-way valve 2. The liquid-outlet one-way valve 2 is integrated in an internal structure of the piston 12 within the liquid pump device 1, resulting in a more compact design, which is particularly beneficial for small products like portable dental irrigators. Therefore, the compact liquid-outlet system of the present disclosure eliminates the need of extra space for installing the liquid-outlet one-way valve 2, resulting in a more compact structure, especially beneficial for small products like portable dental irrigators.

As shown in FIG. 2, the liquid pump device 1 further comprises a transmission mechanism 18 and a driving mechanism 19, and the piston rod 13 is in transmission connection with the driving mechanism 19 through the transmission mechanism 18. The driving mechanism 14 drives the piston rod 13 to perform a reciprocating motion.

The liquid pump device 1 may be a plunger pump; the transmission mechanism 18 and the driving mechanism 19 may both be existing mechanisms; the transmission mechanism 18 may be an eccentric wheel assembly, and the driving mechanism 19 may be a motor assembly.

The liquid-inlet one-way valve 4 may be ball valves (with reset springs) or valve plates.

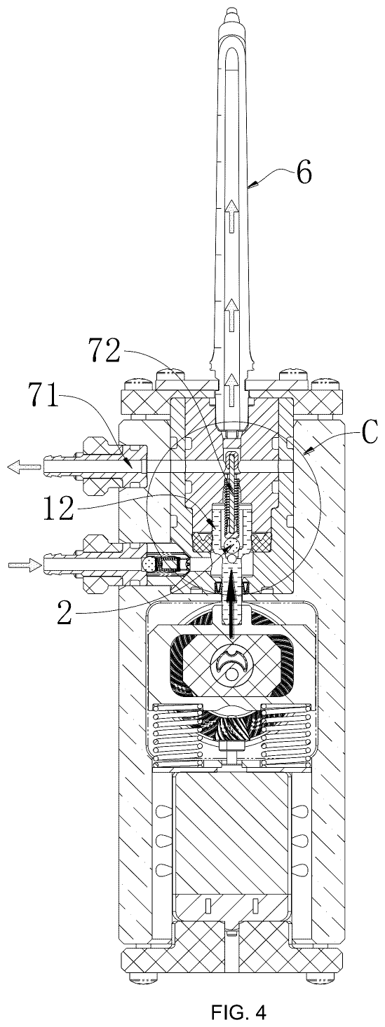

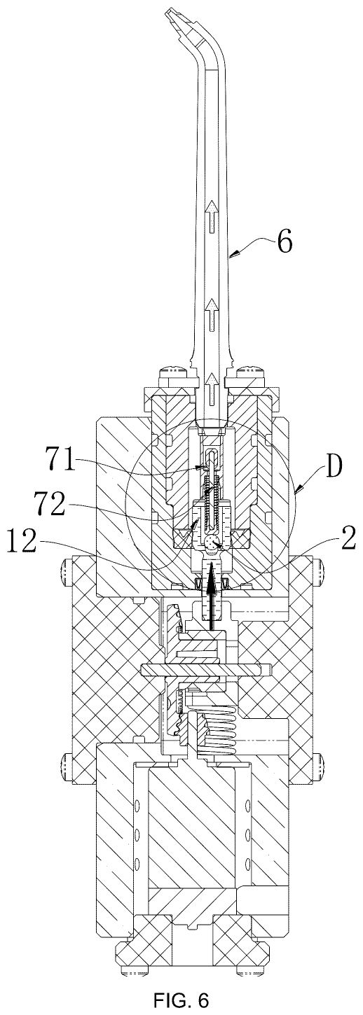

To simplify the liquid-outlet one-way valve 2, as shown in FIGS. 5 and 7, the liquid-outlet one-way valve 2 comprises a liquid-outlet valve chamber 21, a liquid-outlet valve core 22, and a liquid-outlet valve seat 23. The liquid-outlet valve chamber 21 is formed in the piston 12 and has an opening facing the rodless chamber 15, the liquid-outlet valve core 22 is floatingly disposed in the liquid-outlet valve chamber 21, and the liquid-outlet valve seat 23 is formed in the piston 12 and is disposed at a side of the liquid-outlet valve chamber 21 away from the rodless chamber 15. The liquid-outlet valve seat 23 is provided with an overflow hole 231 for communicating the liquid-outlet valve chamber 21 and the rod chamber 14. The liquid-outlet valve core 22 abuts the liquid-outlet valve seat 23 when the piston 12 performs an exhaust stroke, and the liquid-outlet valve core 22 is spaced apart from the liquid-outlet valve seat 23 when the piston 12 performs a suction stroke.

When the piston 12 is pulled back through the piston rod 13 to perform the suction stroke, the liquid-inlet one-way valve 4 switches to the closed state, and the liquid-outlet one-way valve 2 switches to the open state. Specifically, when the piston 12 moves downwards, the rod chamber 14 becomes smaller, and the internal pressure of the rod chamber 14 increases, and since the liquid-inlet flow channel 3 is the upstream side of the liquid-inlet one-way valve 4 and the rod chamber 14 is the downstream side of the liquid-inlet one-way valve 4, in this case the liquid-inlet one-way valve 4 remains in the closed state. Alternatively, when the piston 12 moves downwards, the liquid in the rod chamber 14 is squeezed towards the overflow hole 231, and the liquid-outlet valve core 22 of the liquid-outlet one-way valve 2 is pushed open by the liquid, during which time the liquid in the rod chamber 14 flows into the rodless chamber 15 through the liquid-outlet valve chamber 21.

When the piston 12 is pushed out through the piston rod 13 to perform the exhaust stroke, the liquid-inlet one-way valve 4 switches to the open state, and the liquid-outlet one-way valve 2 switches to the closed state. Specifically, as the piston 12 moves upwards, the rod chamber 14 becomes larger, and the internal pressure of the rod chamber 14 decreases, and since the liquid-inlet flow channel 3 is the upstream side of the liquid-inlet one-way valve 4 and the rod chamber 14 is the downstream side of the liquid-inlet one-way valve 4, in this case the liquid-inlet one-way valve 4 is pushed open by the liquid in the liquid-inlet flow channel 3, and then the liquid flows into the rod chamber 14. Specifically, since the piston 12 is used to push liquid out of the rodless chamber 15, the internal pressure of the rodless chamber 15 increases, such that the liquid-outlet valve core 22 of the liquid-outlet one-way valve 2 abuts the liquid-outlet valve seat 23 in a liquid-tight manner, blocking the overflow hole 231. The liquid in the rodless chamber 15 is squeezed by the piston 12, and is sprayed out of the liquid-outlet flow channel 5. In other words, when the piston 12 performs the exhaust stroke, the liquid-inlet process in the rod chamber 14 happens simultaneously with the liquid-outlet process in the rodless chamber 15.

To achieve flow control during the suction stroke, as shown in FIGS. 2 and 3, the compact liquid-outlet system also comprises a nozzle 6 communicated with the liquid-outlet flow channel 5. The rodless chamber 15 is in a negative pressure state when the piston 12 performs the suction stroke, during which time a volume increase of the rodless chamber 15 is greater than a volume decrease of the rod chamber 14. As the piston 12 moves downward, the negative pressure state of the rodless chamber 15 allows it to create suction on liquid in nozzle 6. This causes the liquid in the nozzle 6 to flow back, compensating for the volume variation difference between the rodless chamber 15 and the rod chamber 14, achieving throttling. When the suction stroke is complete, the nozzle's cavity is almost or partially empty. Afterward, the piston 12 begins the exhaust stroke. Before the flow peak occurs in the liquid pump device 1, the nozzle's cavity is filled with liquid, and therefore the slower-moving portion of the liquid is not sprayed out from the nozzle 6 until a flow peak occurs or is close to occurring. This approach not only maximizes the utilization of the liquid temporarily retained in the nozzle 6, saving liquid and extending the operational time for oral cleaning, but also reduces the liquid spray before the flow peak occurs in the liquid pump device 1, achieving pre-peak throttling, enhancing the pulsatile impacts felt by users and the effective utilization of liquid during oral cleaning for users. Additionally, the combined structure of the piston 12 and the piston rod 13 may be a two-stage stepped shaft structure. Since the piston rod 13 partially occupies the internal space of the rod chamber 14, this design not only reduces the liquid supply to the liquid-inlet flow channel 3 but also enhances the liquid pump device's ability to draw liquid from the nozzle 6.

To reduce the liquid spray after the flow peak occurs in the liquid pump device 1, as shown in FIGS. 4, 5, 6 and 7, the compact liquid-outlet system further comprising a release system 7. The release system 7 comprises a release flow channel 71 and a post-peak release mechanism 72. The release flow channel 71 is communicated with the rodless chamber 15, and the post-peak release mechanism 72 is configured to block the release flow channel 71. The post-peak release mechanism 72 is configured to open the release flow channel 71 only when the piston 12 performs the exhaust stroke and after a flow peak occurs in the liquid pump device 1. When the exhaust stroke proceeds to the second half and a flow of the liquid pump device 1 approaches the flow peak, the release flow channel 71 switches to an open state, allowing part of liquid with lower flow velocity, which occurs after the flow peak, to be recycled through the release flow channel 71, achieving post-peak throttling.

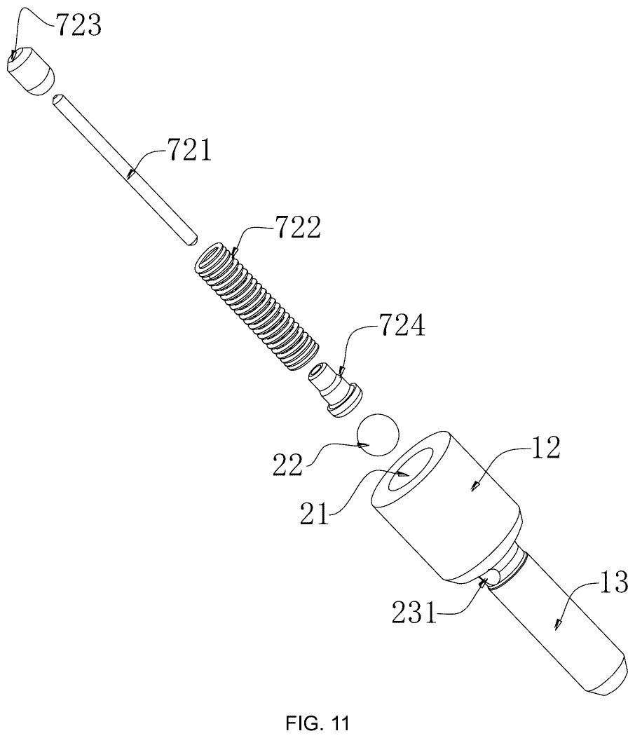

To simplify the post-peak release mechanism 72, as shown in FIGS. 5, 7 and 11, the post-peak release mechanism 72 comprises a moving rod 721 and an elastic reset member (such as compression springs) 722. The moving rod 721 extends through the liquid pump cavity 11, and the elastic reset member 722 is configured for driving the moving rod 721 to reset. A first end of the moving rod 721 is provided with a release valve core 723 for blocking the release flow channel 71, and a second end of the moving rod 721 is provided with a top-abutting member 724. The top-abutting member 724 abuts the liquid-outlet one-way valve 2 or the piston 12 after the flow peak occurs in the liquid pump device 1. When the exhaust stroke is in the second half and after the flow peak occurs in the liquid pump device 1, the liquid-outlet one-way valve 2 or the piston 12 is configured to abut the top-abutting member 724, and subsequently, the top-abutting member 724 moves upward in sync with the piston 12. Since both the top-abutting member 724 and the release valve core 723 are fixed to the moving rod 721, the release valve core 723 moves in sync with the moving rod 721 until it no longer blocks the release flow channel 71, allowing part of the liquid that occurs after the flow peak to flow into the release flow channel 71. When the piston 12 performs the suction stroke, the liquid-outlet one-way valve 2 or the piston 12 is spaced apart from the top-abutting member 724, and the moving rod 721 returns to its original position by the elastic reset member 722, until the release valve core 723 once again blocks the release flow channel 71. Specifically, part of the release flow channel 71 is formed within the liquid pump cavity 11.

To make the fluid flow between the rodless chamber 15 and the release flow channel 71 more smooth, the release flow channel 71 comprises a vertical flow channel segment 711 and a transverse flow channel segment 712. The vertical flow channel segment 711 extends along an axial direction of the liquid pump cavity 11 to communicate with the rodless chamber 15, and the transverse flow channel segment 712 extends along a radial direction of the liquid pump cavity 11 to communicate with the vertical flow channel segment 711. The moving rod 721 extends through the vertical flow channel segment 711 with a clearance fit between the two, and the top-abutting member 724 extends into the rodless chamber 15 or the liquid-outlet valve chamber 21 to limit the liquid-outlet valve core 22 in the liquid-outlet valve chamber 21. Specifically, the vertical flow channel segment 711 is coaxially connected to the rodless chamber 15, making it easier for liquid to flow from the rodless chamber 15 into the vertical flow channel segment 711. Part of the elastic reset member 722 is disposed within the vertical flow channel segment 711. The elastic reset member 722 is sleeved around the moving rod 721. A first end of the elastic reset member 722 abuts an inner wall of the vertical flow channel segment (for example, an inner wall of a stepped hole) 711, and a second end of the elastic reset member 722 abuts the top-abutting member 724, enabling the movement and reset of the moving rod 721. Additionally, another significant innovation of the post-peak release mechanism 72 lies in the location of the top-abutting member 724. Specifically, the top-abutting member 724 extends through the rodless chamber 15 or the liquid-outlet valve chamber 21. This ensures that the liquid-outlet valve core 22 is always limited in the liquid-outlet valve chamber 21, preventing it from floating out and ensuring the proper functioning of the liquid-outlet one-way valve 2. Additionally, yet another significant innovation lies in that the liquid-outlet valve core 22 is spherical and does not have a valve core reset member (such as springs), as detailed below.

When the piston 12 performs the exhaust stroke, the absence of the valve core reset member in the liquid-outlet valve chamber 21 or the rodless chamber 15 results in minimal liquid resistance. When the piston 12 performs the suction stroke, compared to the exhaust stroke, the liquid pump device 1 has smaller power consumption. Since the liquid in the rod chamber 14 can be forcibly pushed into the rodless chamber 15, the dimensions of the liquid-outlet one-way valve 2 can be designed relatively small without affecting the resistance experienced by the piston 12 during the exhaust stroke. Besides, a smaller liquid-outlet one-way valve 2 contributes to a more compact liquid pump device 1.

Furthermore, after the flow peak occurs in the liquid pump device 1, the liquid-outlet valve core 22 abuts the top-abutting member 724, preventing the release valve core 723 from blocking a junction of the vertical flow channel segment 711 and the transverse flow channel segment 712. Specifically, the release valve core 723 is configured to block the vertical flow channel segment 711.

To facilitate liquid discharge, as shown in FIG. 7, the liquid-outlet flow channel 5 comprises a nozzle jack 51 and a guiding channel 52 both formed in the liquid pump cavity 11, and the guiding channel 52 is communicated with the nozzle jack 51 and the rodless chamber 15, respectively. In some embodiments, there are more than one such guiding channels 52, and all the guiding channels are disposed at the outer periphery of the vertical flow channel segment 711, so that more liquid flows into the vertical flow channel segment 711 after the flow peak occurs in the liquid pump device 1, achieving better throttling.

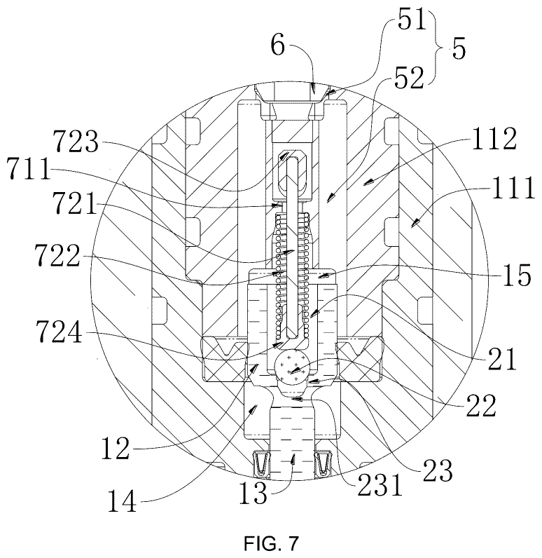

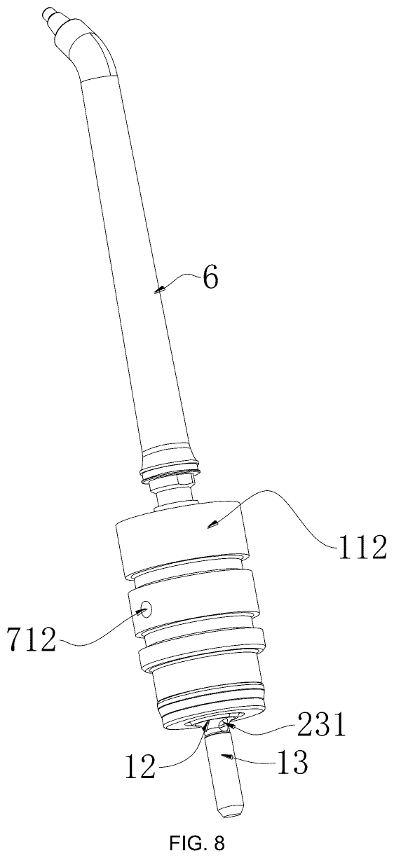

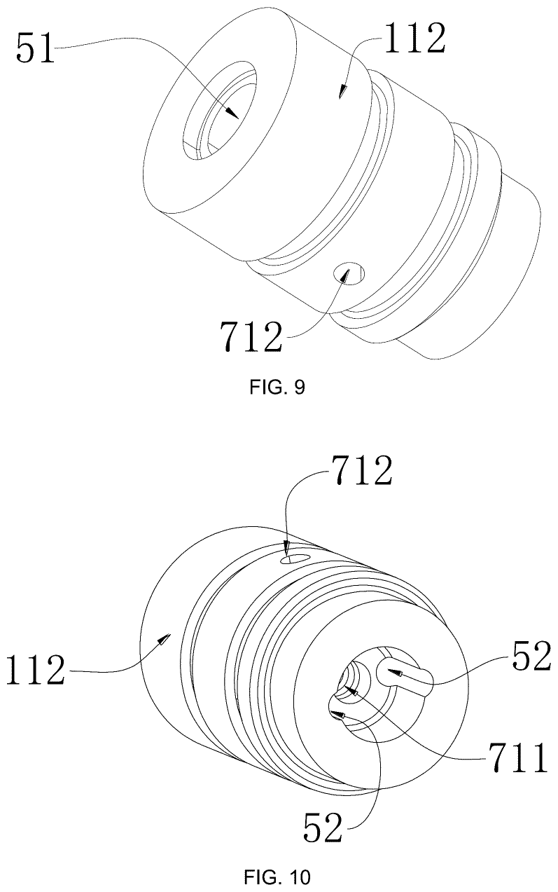

As shown in FIGS. 5 and 7, the liquid pump cavity 11 comprises a liquid-inlet adapter 111 and a liquid-outlet adapter 112 socketed to each other; specifically, the liquid-inlet adapter 111 and the liquid-outlet adapter 112 (outside of the liquid-inlet adapter 111) are connected in a nesting manner. A first groove structure of the liquid-inlet adapter 111 and a second groove structure of the liquid-outlet adapter 112 jointly define the pump chamber of the liquid pump cavity 11. Specifically, the liquid-inlet adapter 111 is provided with a first docking structure for mounting the liquid-inlet one-way valve 4, and the liquid-outlet adapter 112 is provided with a second docking structure for mounting the nozzle 6. Referring to FIGS. 8, 9 and 10, the vertical flow channel segment 711, the transverse flow channel segment 712, the nozzle jack 51, and the guiding channel 52 are formed on the liquid-outlet adapter 112, so as to simplify components and enhance the compactness of the liquid pump device 1.

To further enhance the liquid-tightness between the liquid pump cavity 11 and both the piston 12 and the piston rod 13, as shown in FIG. 5, the liquid pump cavity 11 is provided with a first sealing ring 16 and a second sealing ring 17. The first sealing ring 16 is slidably arranged around the piston 12 in a liquid-tight manner, the second sealing ring 17 is slidably arranged around the piston rod 13 in a liquid-tight manner, and a maximum sealing pressure of the first sealing ring 16 is greater than a maximum sealing pressure of the second sealing ring 17. The first sealing ring 16 can withstand high pressure, and while a small amount of leakage is acceptable, it doesn't affect its function. This design reduces the tightness requirements for the high-pressure sealing ring. On the other hand, no leakage is allowed for the second sealing ring 17. Since the second sealing ring 17 operates at lower pressure, this significantly improves the overall working conditions and greatly extends its service life. Unlike existing dental irrigators that only use high-pressure sealing rings, which must withstand significant pressure while preventing leaks, the compact liquid-outlet system of the present disclosure lowers the performance demands for the sealing rings and effectively prolongs their lifespan.

The oral cleaning method applies the above compact liquid-outlet system, and is performed by:
pulling back the piston 12 through the piston rod 13 to perform the suction stroke, closing the liquid-inlet one-way valve 4, and opening the liquid-outlet one-way valve 2, such that liquid in the rod chamber 14 flows to the rodless chamber 15 through the liquid-outlet one-way valve 2, and liquid in the nozzle 6 flows back to the rodless chamber 15;
pushing out the piston 12 through the piston rod 13 to perform the exhaust stroke, opening the liquid-inlet one-way valve 4, and closing the liquid-outlet one-way valve 2, such that liquid in the liquid-inlet flow channel 3 flows to the rod chamber 14 through the liquid-inlet one-way valve 4, and liquid in the rodless chamber 15 flows to the nozzle 6 through the liquid-outlet flow channel 5; part of the liquid in the rodless chamber 15 flows back to a liquid storage tank through the release flow channel 71 after the flow peak occurs in the liquid pump device 1.

In the present oral cleaning method, when the piston 12 performs the suction stroke, the liquid in the nozzle 6 flows back to the rodless chamber 15, allowing for pre-peak throttling (see above for details); when the piston 12 performs the suction stroke, part of the liquid in the rodless chamber 15 flows back to the liquid storage tank through the release flow channel 71, achieving post-peak throttling (see above system embodiments for details). Furthermore, the compact liquid-outlet system is highly convenient for users during oral cleaning, due to its compact design. Additionally, the oral cleaning method of the present disclosure conserves liquid before and/or after flow peaks, enhancing convenience during oral hygiene procedures.

In summary, the compact liquid-outlet system of the present disclosure eliminates the need of extra space for installing the liquid-outlet one-way valve, resulting in a more compact structure, especially beneficial for small products like portable dental irrigators. Additionally, the oral cleaning method of the present disclosure conserves liquid before and/or after flow peaks, enhancing convenience during oral hygiene procedures. Therefore, the present disclosure effectively overcomes various shortcomings in the existing technology and has high industrial utilization value.

The above-mentioned embodiments are for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the scope of the present disclosure.

1. A compact liquid-outlet system, comprising:
a liquid pump device (1) comprising a liquid pump cavity (11), a piston (12) and a piston rod (13), wherein the piston (12) is slidably disposed in the liquid pump cavity (11), and the piston rod (13) extends through the liquid pump cavity (11) in a liquid-tight manner and is connected to the piston (12); wherein the piston (12) divides a pump chamber of the liquid pump cavity (11) into a rod chamber (14) and a rodless chamber (15); wherein the piston (12) comprises a liquid-outlet one-way valve (2) allowing only liquid to flow from the rod chamber (14) to the rodless chamber (15);
a liquid-inlet flow channel (3) communicated with the rod chamber (14) through a liquid-inlet one-way valve (4); and
a liquid-outlet flow channel (5) communicated with the rodless chamber (15).

2. The compact liquid-outlet system according to claim 1, wherein the liquid-outlet one-way valve (2) comprises a liquid-outlet valve chamber (21), a liquid-outlet valve core (22), and a liquid-outlet valve seat (23), wherein the liquid-outlet valve chamber (21) is formed in the piston (12) and has an opening facing the rodless chamber (15), the liquid-outlet valve core (22) is floatingly disposed in the liquid-outlet valve chamber (21), and the liquid-outlet valve seat (23) is formed in the piston (12) and is disposed at a side of the liquid-outlet valve chamber (21) away from the rodless chamber (15); wherein the liquid-outlet valve seat (23) is provided with an overflow hole (231) for communicating the liquid-outlet valve chamber (21) and the rod chamber (14); wherein the liquid-outlet valve core (22) abuts the liquid-outlet valve seat (23) when the piston (12) performs an exhaust stroke, and the liquid-outlet valve core (22) is spaced apart from the liquid-outlet valve seat (23) when the piston (12) performs a suction stroke.

3. The compact liquid-outlet system according to claim 1, wherein the compact liquid-outlet system further comprises a nozzle (6) communicated with the liquid-outlet flow channel (5), wherein the rodless chamber (15) is in a negative pressure state when the piston (12) performs a suction stroke, during which time a volume increase of the rodless chamber (15) is greater than a volume decrease of the rod chamber (14).

4. The compact liquid-outlet system according to claim 1, further comprising a release system (7) comprising a release flow channel (71) and a post-peak release mechanism (72), wherein the release flow channel (71) is communicated with the rodless chamber (15), and the post-peak release mechanism (72) is configured to block the release flow channel (71), wherein the post-peak release mechanism (72) is configured to open the release flow channel (71) only when the piston (12) performs the exhaust stroke and after a flow peak occurs in the liquid pump device (1).

5. The compact liquid-outlet system according to claim 4, wherein the post-peak release mechanism (72) comprises a moving rod (721) and an elastic reset member (722), wherein the moving rod (721) extends through the liquid pump cavity (11), and the elastic reset member (722) is configured for driving the moving rod (721) to reset, wherein a first end of the moving rod (721) is provided with a release valve core (723) for blocking the release flow channel (71), and a second end of the moving rod (721) is provided with a top-abutting member (724), wherein the top-abutting member (724) abuts the liquid-outlet one-way valve (2) or the piston (12) after the flow peak occurs in the liquid pump device (1).

6. The compact liquid-outlet system according to claim 5, wherein the release flow channel (71) comprises a vertical flow channel segment (711) and a transverse flow channel segment (712), wherein the vertical flow channel segment (711) extends along an axial direction of the liquid pump cavity (11) to communicate with the rodless chamber (15), and the transverse flow channel segment (712) extends along a radial direction of the liquid pump cavity (11) to communicate with the vertical flow channel segment (711); wherein the moving rod (721) extends through the vertical flow channel segment (711) in a clearance manner, and the top-abutting member (724) extends into the rodless chamber (15) or the liquid-outlet valve chamber (21) to limit the liquid-outlet valve core (22) in the liquid-outlet valve chamber (21).

7. The compact liquid-outlet system according to claim 1, wherein the liquid pump cavity (11) comprises a liquid-inlet adapter (111) and a liquid-outlet adapter (112) socketed to each other, and a first groove structure of the liquid-inlet adapter (111) and a second groove structure of the liquid-outlet adapter (112) jointly define the pump chamber of the liquid pump cavity (11).

8. The compact liquid-outlet system according to claim 1, wherein the liquid-outlet flow channel (5) comprises a nozzle jack (51) and a guiding channel (52) both formed in the liquid pump cavity (11), and the guiding channel (52) is communicated with the nozzle jack (51) and the rodless chamber (15), respectively.

9. The compact liquid-outlet system according to claim 1, wherein the liquid pump cavity (11) is provided with a first sealing ring (16) and a second sealing ring (17), wherein the first sealing ring (16) is slidably arranged around the piston (12) in a liquid-tight manner, the second sealing ring (17) is slidably arranged around the piston rod (13) in a liquid-tight manner, and a maximum sealing pressure of the first sealing ring (16) is greater than a maximum sealing pressure of the second sealing ring (17).

10. An oral cleaning method using a compact liquid-outlet system according to claim 4, comprising:
pulling back the piston (12) through the piston rod (13) to perform the suction stroke, closing the liquid-inlet one-way valve (4), and opening the liquid-outlet one-way valve (2), such that liquid in the rod chamber (14) flows to the rodless chamber (15) through the liquid-outlet one-way valve (2), and liquid in the nozzle (6) flows back to the rodless chamber (15);
pushing out the piston (12) through the piston rod (13) to perform the exhaust stroke, opening the liquid-inlet one-way valve (4), and closing the liquid-outlet one-way valve (2), such that liquid in the liquid-inlet flow channel (3) flows to the rod chamber (14) through the liquid-inlet one-way valve (4), and liquid in the rodless chamber (15) flows to the nozzle (6) through the liquid-outlet flow channel (5); wherein part of the liquid in the rodless chamber (15) flows back to a liquid storage tank through the release flow channel (71) after the flow peak occurs in the liquid pump device (1).
